(19) United States
(12) Patent Application Publication
(10) Pub. No.: US 2025/0346251 A1
(43) Pub. Date: Nov. 13, 2025

(54) Method and Device for Learning Image Network in Dynamic Environment

(71) Applicants: Hyundai Motor Company, Seoul (KR); Kia Corporation, Seoul (KR)

(72) Inventor: Jin Ho Park, Seoul (KR)

(21) Appl. No.: 19/032,736

(22) Filed: Jan. 21, 2025

(30) Foreign Application Priority Data
May 9, 2024 (KR) 10-2024-0061314

(51) Int. Cl. B60W 60/00; G06T 7/55; G06T 7/80; G06V 10/82

(52) U.S. Cl. CPC B60W 60/001; G06T 7/55; G06T 7/80; G06V 10/82

(57) ABSTRACT

A method for controlling autonomous driving of a vehicle is introduced. The method may comprise, outputting, by a depth network, an inference depth from a sequence image, outputting, by a pose network and based on the sequence image, an initial inference pose, generating, based on a synthetic depth, a dynamic mask, wherein the synthetic depth is generated based on the inference depth and the initial inference pose, generating, by the pose network and based on the sequence image and the dynamic mask, a refined inference pose, based on the sequence image, the inference depth, and the refined inference pose, training a synthetic image model may comprise the depth network and the pose network to generate a synthetic image, outputting a signal associated with the synthetic image, and controlling, based on the signal, autonomous driving of the vehicle.

### CROSS REFERENCE TO RELATED APPLICATION

The present application claims the benefit of priority to Korean Patent Application No.10-2024-0061314, filed in the Korean Intellectual Property Office on May 9, 2024, the entire contents of which is incorporated herein for all purposes by reference.

### TECHNICAL FIELD

The present disclosure relates to a method and device for learning an image network in a dynamic environment, and more specifically, to a method and device for learning an image network that improves the learning performance of depth estimation by realizing accurate pose inference of an image having a dynamic environment.

### BACKGROUND

The matters described in this Background section are only for enhancement of understanding of the background of the disclosure, and should not be taken as acknowledgment that they correspond to prior art already known to those skilled in the art.

Vehicles are commercialized with autonomous driving functions for driving convenience. Autonomous driving functions are being developed so that the vehicle may control driving control as much as possible without driver intervention. Autonomous driving may process perception that detects the surrounding environment and estimates the vehicle's location, determination that determines driving behavior based on the recognized environment and estimated location, and control of actuators according to the determined behavior.

The surrounding environment may be recognized from sensor data mounted on the vehicle, such as an image, and this image may be used to estimate object detection information, semantic segmentation information, and depth information using computer vision technology. Among the information estimated by computer vision, depth information may be used for recognizing various spatial information in the autonomous driving field.

Depth information may be estimated by deep learning-based supervised learning, and supervised learning for depth estimation requires a large number of GT depth maps to secure performance, which may cause a large cost for network learning. In order to reduce the cost consumed by network learning to infer depth information, self-supervised depth estimation methods that may be learned with an image sequence or stereo image pair are considered.

The above method may use a depth model and a pose model learned to infer depth and pose based on an image acquired from a sensor, and generates a synthetic image based on the inferred depth and inferred pose. The depth model may be learned together with the pose model using a loss function based on a difference between the acquired image and the synthetic image.

In terms of estimating depth and pose simultaneously, the self-supervised depth estimation method that uses the image sequence for learning may have similar characteristics and limitations to Structure from Motion (SfM).

SfM may assume that the environment in which the image sequence is acquired is static, but in general, matching between image pairs may be inaccurate in a dynamic environment, so the accuracy of pose estimation also may deteriorate.

This is the similar or same problem that occurs in the pose model of self-supervised depth estimation, and when the results of the pose model are accumulated and compared with the GT trajectory, drifting may occur between the predicted trajectory and the GT trajectory. Therefore, in order to improve the learning performance of the image network including depth estimation, accurate pose inference of images with a dynamic environment is desirable.

### SUMMARY

According to the present disclosure, a method for controlling autonomous driving of a vehicle, the method may comprise, outputting, by a depth network, an inference depth from a sequence image, outputting, by a pose network and based on the sequence image, an initial inference pose, generating, based on a synthetic depth, a dynamic mask, wherein the synthetic depth is generated based on the inference depth and the initial inference pose, generating, by the pose network and based on the sequence image and the dynamic mask, a refined inference pose, based on the sequence image, the inference depth, and the refined inference pose, training a synthetic image model may comprise the depth network and the pose network to generate a synthetic image, outputting a signal associated with the synthetic image, and controlling, based on the signal, autonomous driving of the vehicle.

The method, wherein the dynamic mask is generated as a depth map representing a dynamic region, wherein the dynamic region is determined based on a difference between the synthetic depth and the inference depth.

The method, wherein the dynamic mask is a depth map, wherein the depth map is generated to match a size of the sequence image based on having a spatial dimension of a feature and filter out a dynamic region from the feature by extracting the feature from the sequence image.

The method, wherein the sequence image may comprise a source image and a target image related to the source image in time series, wherein the inference depth may comprise a source inference depth generated based on the source image and a target inference depth generated based on the target image, and wherein the dynamic mask is generated for each of the source image and the target image.

The method, wherein the generating the dynamic mask may comprise, estimating a three-dimensional (3D) target point of a target pixel position in the target image based on, a target pixel position of the target inference depth, target depth information of the target inference depth, and an intrinsic matrix related to an internal geometry of the sequence image, applying the initial inference pose to the 3D target point to transform the 3D target point into a 3D source point of the source image, determining a source pixel position corresponding to the target pixel position, wherein the source pixel position is projected at the source inference depth by applying the intrinsic matrix to the 3D source point, warping the source inference depth to the target pixel position to generate the synthetic depth, and generating, based on the synthetic depth and the target inference depth, the dynamic mask.

The method, wherein the synthetic image model is a view synthesis based self-supervised depth estimation model, wherein the view synthesis based self-supervised depth estimation model is trained based on a loss function, and wherein the loss function utilizes a loss based on the synthetic image and the target image to which weights of the dynamic mask are respectively applied.

The method, wherein the generating the refined inference pose may comprise, extracting a feature of the sequence image, outputting, based on the dynamic mask, a feature filtered to block a dynamic region from the feature, and generating the refined inference pose by encoding the filtered feature.

The method, wherein the extracting the feature may comprise generating, based on a plurality of channels having different feature characteristics, a channel aggregated feature, and wherein the channel has a kernel set to output a feature with the same size as the sequence image.

The method, wherein the sequence image may comprise a source image and a target image related to the source image in time series, wherein the dynamic mask is generated for each of the source image and the target image, wherein the extracting the feature may comprise, applying the dynamic mask to each of a feature of the source image and a feature of the target image, wherein the dynamic mask corresponds to each of the feature of the source image and the feature of the target image, and outputting each filtered feature corresponding to each of the source image and the target image, and wherein the generating the refined inference pose may comprise concatenating each filtered feature and encoding the concatenated features to generate the refined inference pose.

The method may further comprise, after the generating the refined inference pose, performing, generating, based on a synthetic depth, a subsequent dynamic mask, wherein the synthetic depth is generated based on the inference depth and the refined inference pose, generating the inference depth to replace the dynamic mask, and generating, based on the sequence image and the subsequent dynamic mask, a subsequent refined inference pose to replace the refined inference pose.

According to the present disclosure, an apparatus for controlling autonomous driving of a vehicle, the apparatus may comprise, a processor, and a memory configured to store at least one instruction, that when executed by the processor, is configured to cause the apparatus to, output, by a depth network, an inference depth from a sequence image, output, by a pose network and based on the sequence image, an initial inference pose, generate, by a dynamic region estimator and based on a synthetic depth, a dynamic mask, wherein the synthetic depth is generated based on the inference depth and the initial inference pose, generate, by the pose network and based on the sequence image and the dynamic mask, a refined inference pose, and based on the sequence image, the inference depth, and the refined inference pose, train a synthetic image model may comprise the depth network and the pose network to generate a synthetic image, output a signal associated with the synthetic image, and control, based on the signal, autonomous driving of the vehicle.

The apparatus, wherein the dynamic mask is generated as a depth map representing a dynamic region, wherein the dynamic region is determined based on a difference between the synthetic depth and the inference depth.

The apparatus, wherein the dynamic mask is a depth map, wherein the depth map is generated to match a size of the sequence image based on having a spatial dimension of a feature and filter out a dynamic region from the feature by extracting the feature from the sequence image.

The apparatus, wherein the sequence image may comprise a source image and a target image related to the source image in time series, wherein the inference depth may comprise a source inference depth generated based on the source image and a target inference depth generated based on the target image, and wherein the dynamic mask is generated for each of the source image and the target image.

The apparatus, wherein the dynamic mask is generated by, estimating a 3D target point of a target pixel position in the target image based on, a target pixel position of the target inference depth, target depth information of the target inference depth, and an intrinsic matrix related to an internal geometry of the sequence image, applying the initial inference pose to the 3D target point to transform the 3D target point into a 3D source point of the source image, determining a source pixel position corresponding to the target pixel position, wherein the source pixel position is projected at the source inference depth by applying the intrinsic matrix to the 3D source point, warping the source inference depth to the target pixel position to generate the synthetic depth, and generating, based on the synthetic depth and the target inference depth, the dynamic mask.

The apparatus, wherein the synthetic image model is a view synthesis based self-supervised depth estimation model, wherein the view synthesis based self-supervised depth estimation model is trained based on a loss function, and wherein the loss function utilizes a loss based on the synthetic image and the target image to which weights of the dynamic mask are respectively applied.

The apparatus, wherein the refined inference pose is generated by, extracting a feature of the sequence image, outputting, based on the dynamic mask, a feature filtered to block a dynamic region from the feature, and generating the refined inference pose by encoding the filtered feature.

The apparatus, wherein the extracting the feature may comprise generating, based on a plurality of channels having different feature characteristics, a channel aggregated feature, and wherein the channel has a kernel set to output a feature with the same size as the sequence image.

The apparatus, wherein the sequence image may comprise a source image and a target image related to the source image in time series, wherein the dynamic mask is generated for each of the source image and the target image, wherein the extracting the feature may comprise, applying the dynamic mask to each of a feature of the source image and a feature of the target image, wherein the dynamic mask corresponds to each of the feature of the source image and the feature of the target image, and outputting each filtered feature corresponding to the source image and the target image, and wherein the generating the refined inference pose may comprise concatenating each filtered feature and encoding the concatenated features to generate the refined inference pose.

The apparatus, wherein the at least one instruction, when executed by the processor, is configured to cause the apparatus to, after generating the refined inference pose, perform, generating, based on a synthetic depth, a subsequent dynamic mask, wherein the synthetic depth is generated based on the inference depth and the refined inference pose, generating the inference depth to replace the dynamic mask, and generating, based on the sequence image and the subsequent dynamic mask, a subsequent refined inference pose to replace the refined inference pose.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 shows an example of modules that constitute a learning device according to an example of the present disclosure;

FIG. 2 shows an example of a method of learning an image network according to another example of the present disclosure;

FIG. 3 shows an example of the structure of a synthetic image model used in implementing a method of learning an image network according to another example of the present disclosure;

FIG. 4 shows an example of the structure of a pose network;

FIG. 5 shows an example of a process of generating a synthetic depth and a dynamic mask;

FIG. 6 shows an example of generation of a dynamic mask;

FIG. 7 shows an example of a mobility device communicating with another device to transmit and receive data; and

FIG. 8 shows an example of modules constituting a mobility device according to the present disclosure.

### DETAILED DESCRIPTION

Herein after, examples of the present disclosure are described in detail with reference to the accompanying drawings so that those having ordinary skill in the art may easily implement the present disclosure. However, examples of the present disclosure may be implemented in various different ways and thus the present disclosure is not limited to the examples described therein.

In describing examples of the present disclosure, well-known functions or constructions have not been described in detail since a detailed description thereof may have unnecessarily obscured the gist of the present disclosure. The same constituent elements in the drawings are denoted by the same reference numerals and a repeated or duplicative description of the same elements has been omitted.

In the present disclosure, when an element is simply referred to as being “connected to”, “coupled to” or “linked to” another element, this may mean that an element is “directly connected to”, “directly coupled to”, or “directly linked to” another element or this may mean that an element is connected to, coupled to, or linked to another element with another element intervening therebetween. In addition or alternative, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically stated otherwise. Accordingly, a first element in an example may be termed a second element in another example, and, similarly, a second element in an example could be termed a first element in another example, without departing from the scope of the present disclosure.

In the present disclosure, elements are distinguished from each other for clearly describing each feature, but this does not necessarily mean that the elements are separated. In other words, a plurality of elements may be integrated in one hardware or software unit, or one element may be distributed and formed in a plurality of hardware or software units. Therefore, even if not mentioned otherwise, such integrated or distributed examples are included in the scope of the present disclosure.

In the present disclosure, elements described in various examples do not necessarily mean essential elements, and some of them may be optional elements. Therefore, an example composed of a subset of elements described in an example is also included in the scope of the present disclosure.

Examples including other elements in addition or alternative to the elements described in the various examples are also included in the scope of the present disclosure.

The advantages and features of the present disclosure and the ways of attaining them should become apparent to those of ordinary skill in the art with reference to examples of the present disclosure described below in detail in conjunction with the accompanying drawings. The examples of the present disclosure, however, may be embodied in many different forms and should not be constructed as being limited to the example examples set forth herein. Rather, the examples described herein are provided to make this disclosure more complete and to fully convey the scope of the present disclosure to those having ordinary skill in the art to which the present disclosure pertains.

In the present disclosure, each of phrases such as “A or B”, “at least one of A and B”, “at least one of A or B”, “A, B or C”, “at least one of A, B and C”, and each of the phrases such as “at least one of A, B or C” and “at least one of A, B, C or combination thereof” may include any one or all possible combinations of the items listed together in the corresponding one of the phrases.

Specifically, for purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

In the present disclosure, expressions of location relations used in the present specification such as “upper”, “lower”, “left” and “right” are employed for the convenience of explanation, and when drawings illustrated in the present specification are inversed, the location relations described in the specification may be inversely understood. When a component, device, element, or the like of the present disclosure is described as having a purpose or performing an operation, function, or the like, the component, device, or element should be considered herein as being “configured to” meet that purpose or perform that operation or function.

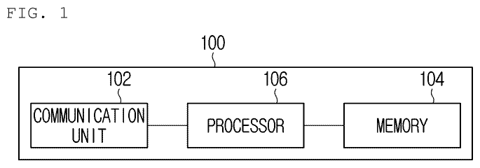

Hereinafter, a learning device implementing a method of learning an image network in a dynamic environment according to an example of the present disclosure will be described with reference to FIG. 1. FIG. 1 shows an example of modules constituting a learning device according to an example of the present disclosure.

Referring to FIG. 1, a learning device 100 may learn an image network that performs a task based on an image. In the present disclosure, the task may include at least one of depth estimation or pose estimation, and the image network may include at least one of a depth network or a pose network. The depth network may be a neural network designed to estimate depth information from a sequence of images. In the context of autonomous driving, the depth network may interpret distances to various elements in the environment. The depth network may be integral to creating a depth map, which may provide 3D spatial information by estimating how far objects are from the camera. The depth network may learn depth estimations from sequences of images without labeled depth data.

The pose network may be responsible for determining the relative position and orientation (pose) of a sensor (e.g., a camera) or vehicle between frames. The pose network may work in conjunction with the depth network. The pose network may process pairs of images to infer the camera's movement. The pose estimation may be refined by using dynamic regions, which help to distinguish moving objects from static ones, thus improving the accuracy of a learning apparatus (e.g., learning device 100).

Specifically, the learning device 100 may learn the depth network and the pose network by using a synthetic image model including the depth network and the pose network, and an additional module for accurate inference of the pose network in the model. The synthetic image model may a component of a system that uses both the depth and pose networks to generate synthetic images. Synthetic images may be created by transforming the inferred depth and pose data into visual representations, simulating new viewpoints or perspectives. The synthetic images may be generated based on the synthetic image model. These images may represent a new viewpoint of a scene that a vehicle may potentially encounter. The synthetic images may provide training feedback, enabling the network to refine its depth and pose estimations, thus improving the accuracy and reliability of autonomous driving decisions.

The additional module may be regarded as a structure belonging to the synthetic image model, as in the present disclosure, or may be a separate member from the synthetic image model. Here, the network may be referred to in various ways, for example, as a model, an estimation model, a learning model, etc. The additional module may be a dynamic region estimator that generates a dynamic mask that filters a dynamic region from a feature of a sequence image. For example, the dynamic mask may identify and isolate moving objects within a scene. This mask may be applied to the pose network to ensure that dynamic elements do not interfere with the pose estimation. By filtering out regions affected by movement, the dynamic mask may allow for more accurate tracking of static background elements, which is useful for precise pose estimation in environments with both moving and static objects (e.g., autonomous driving of a vehicle).

Specifically, the learning device 100 may generate a dynamic mask using the dynamic region estimator, and generate a refined inference pose based on the dynamic mask in the pose network. The learning device 100 may be a device that trains the depth network and the pose network by training a synthetic image model that generates a synthetic image based on a sequence image, an inference depth, and a refined inference pose. Inference depth may refer to estimated depth information produced by the depth network for a given image sequence. This depth may not be ground-truth data but may be inferred by the depth network based on the input images and prior training. Inference depth may represent the network's prediction of distances to objects, forming the foundation for further synthetic processing to enhance the depth accuracy.

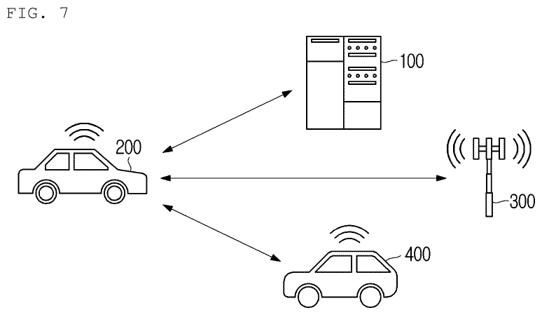

The learning device 100 distributes the learned depth network to a mobility device (see 200 of FIG. 7) so that estimation performance is improved due to accurate pose inference of an image having a dynamic environment, and thus the mobility device 200 may utilize the distributed depth network for driving control.

The mobility device 200 may refer to a device that may move to a specific point. The mobility device 200 may be any one of devices such as a ground vehicle that runs on the ground, a mobile robot that is autonomously or remotely controlled, a work robot for a specific purpose, etc. In addition or alternative, the mobility device 200 is not limited to a ground mobility device, and may be, for example, an air mobility device, a water mobility device for water transportation, or an underwater mobility device (e.g., a submarine). The mobility device 200 may be driven autonomously or passively. The mobility device 200 which may be driven autonomously may be implemented as semi-autonomous driving or fully autonomous driving. Fully autonomous driving may be provided as autonomous movement in which a controller of the mobility device 200 completely controls control without user intervention even when a driving situation is uncertain. Semi-autonomous driving may be provided as autonomous movement that requires driver intervention depending on a specific driving situation. Semi-autonomous driving may be implemented by having the controller of the mobility device 200 deactivate autonomous driving when the above situation occurs and transfer control to the user, thereby allowing the user to perform manual driving. According to the level of autonomous driving defined by the Society of Automotive Engineers (SAE), semi-autonomous driving corresponds to autonomous driving levels 1 to 4, and fully autonomous driving corresponds to level 5.

Specifically, an automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of a synthetic image model) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of a synthetic image model) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of a synthetic image model) described herein. Minimum risk maneuver (MRM) operation(s) may also be controlled, for example, based on one or more features (e.g., features of a synthetic image model) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state.

A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time. Biased driving operation(s) may also be controlled, for example, based on one or more features (e.g., features of a synthetic image model) described herein.

A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control.

For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc.

For example, during a lane change, the driving control system may bias the lateral distance to keep a safer gap from adjacent vehicles, considering factors such as the vehicle's speed, road conditions, and/or the presence of obstacles, etc. One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of a synthetic image model) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

The learning device 100 may be, for example, a device, such as a server, provided separately from the mobility device 200, operated by a vehicle manufacturer or a management agency that provides autonomous driving services. If the learning device 100 is a server operated by a vehicle manufacturer or management agency that supports autonomous driving, it may receive connected data of the mobility device 200 or transmit data desired for autonomous driving. In order to support autonomous driving and various services of the mobility device 200, the learning device 100 may transmit various information and software modules used for controlling the mobility device 200 to the mobility device 200 in response to requests and data transmitted from the mobility device 200 and a user device. In the present disclosure, the functions of the learning device 100 related to the learning method according to the example will be mainly described.

The learning device 100 may include a communication unit 102, a memory 104, and a processor 106. The communication unit 102 may support mutual communication with the mobility device 200 or 400, an ITS device 300, etc. In the present disclosure, the communication unit 102 may be a communication interface that receives various data and networks (or algorithms) used to train a learning model that supports driving and convenience functions of the mobility device 200, and transmits information and networks related to the learning model to the mobility device 200. In addition or alternative, the communication unit 102 may be a communication module that receives data generated or stored during driving from the mobility device 200, and transmits information that supports driving, such as map information, environmental information that recognizes objects around the mobility device 200, traffic information, weather information, etc. to the mobility device 200. The communication unit 102 may be a communication module that transmits applications related to driving and convenience functions.

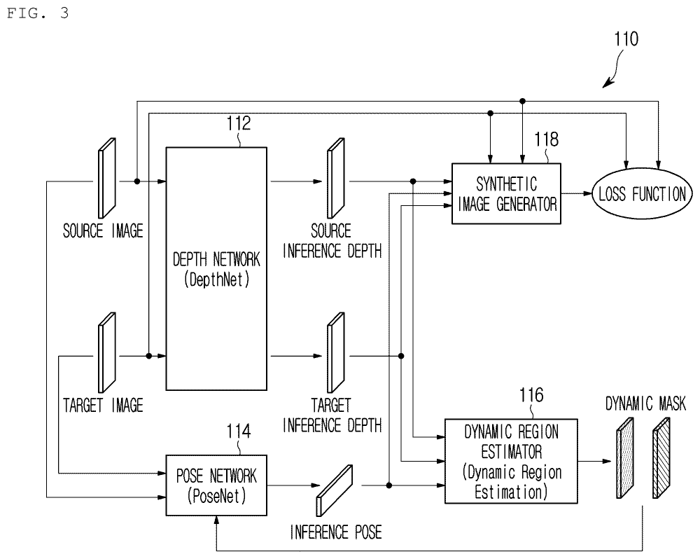

The memory 104 may store a program and various data for controlling the learning device 100, and load a program or read and record the data according to the request of the processor 106. The memory 104 may manage a synthetic image model and learning data utilized for learning the model. The synthetic image model may be configured to include a functional module 110 illustrated in FIG. 3, which will be described later. The learning data may include images collected from the plurality of mobility devices 200 and 400 and/or a DB for typical learning data, depth maps, depth information provided in a point cloud format, etc. In addition or alternative to the data described above, the memory 104 may also hold applications for implementing driving and convenience functions of the mobility device 200, map information, traffic information, weather information, and other various information affecting driving.

The processor 106 may perform overall control of the learning device 100. The processor 106 may be configured to execute applications and instructions stored in the memory 104.

Specifically, the processor 106 may control the learning device 100 to train a learning model stored in the memory 104 using the learning data described above, and to distribute the trained learning model to the mobility device 200. The learning model utilized for training may include a synthetic image model 110 including a depth network, a pose network, a synthetic image generator, and a dynamic range estimator. The distributed learning model may be, for example, a depth network separated from the synthetic image model 110. The distributed model may be, for example, a depth network and a pose network.

The processor 106 may determine learnable parameters for constructing functional modules of FIG. 3, i.e., sub-models, that constitute the learning model, through training. In addition or alternative, the processor 106 may receive, from the mobility device 200 and 400, the learning model distributed to the mobility devices 200 and 400, such as feedback information according to operation of the depth network and data similar to the learning data described above, and update the depth network based on received information and data. The processor 106 may distribute the updated depth network to the mobility devices 200 and 400.

Specifically, the processor 106 may perform processing for outputting an inference depth from a sequence image by a depth network (see 112 of FIG. 3), and for outputting an initial inference pose based on the sequence image by a pose network (see 114 of FIG. 3). The initial inference pose may be a preliminary estimate of a sensor's position and orientation relative to other frames in the sequence image. The initial inference pose may be generated before any dynamic masking or pose refinement. The initial inference pose may be used as a baseline to help determine more refined poses and to enable a better understanding of the vehicle's movement within its environment.

The processor 106 may perform processing for generating a dynamic mask based on the synthetic depth and the inference depth generated using the inference depth and the initial inference pose by a dynamic region estimator (see 116 of FIG. 3). The synthetic depth may be a refined depth estimation generated by combining the initial inference depth and pose. This process synthesizes depth that may account for dynamic regions, assisting to correct inaccuracies caused by moving objects or dynamic environments. Synthetic depth may enhance the robustness of the depth network by reducing errors in complex scenarios like those encountered in autonomous driving.

In addition or alternative, the processor 106 may implement processing for generating a refined inference pose based on the sequence image and the dynamic mask by the pose network 114.

The processor 106 may perform processing for training the depth network 112 and the pose network 114 by training the synthetic image model 110 to generate a synthetic image based on the sequence image, the inference depth, and the refined inference pose.

In addition or alternative, the processor 106 may perform processing for supporting driving and convenience functions of the mobility device 200. In the present disclosure, the processor 106 may be implemented as a single processing module, for example. In another example, the processing according to the above-described matters may be distributed and processed in a plurality of processing modules, and the processor 106 may be collectively referred to as a plurality of processing modules in the present disclosure.

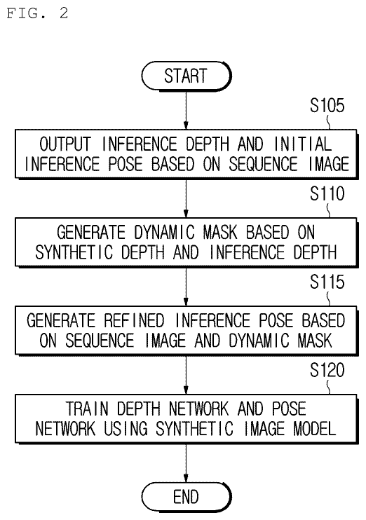

Hereinafter, a method of learning an image network according to another example of the present disclosure will be described in detail with reference to FIGS. 2 and 3.

FIG. 2 shows an example of a method of learning an image network according to another example of the present disclosure. FIG. 3 shows an example of the structure of a synthetic image model used in implementing a method of learning an image network according to another example of the present disclosure. In FIG. 3, a module implementing the learning method may be a software module processed by the processor 106, and the processor 106 may process requests from the modules listed in FIG. 3.

In the present disclosure, the learning model according to the example is mainly described as being trained only in the learning device 100, but the method of learning the image network described below may be distributed to and processed in the learning device 100 and other devices, as long as it does not conflict with the description below. The other devices may be, for example, other servers and/or the mobility devices 200 and 400. Hereinafter, the processor 106 of the learning device 100 may simply be described as the learning device 100 for convenience of explanation, or these terms may be used interchangeably.

For convenience, FIG. 2 is described by way of an example in which the steps are performed by a processor (e.g., processor 106 or control circuitry). One, some, or all steps of FIG. 2, or portions thereof, may be performed by one or more other circuits. One or some, steps of FIG. 2 may be omitted, performed in other orders, and/or otherwise modified, and/or one or more additional steps may be added.

Referring to FIG. 2, the processor 106 of the learning device 100 may generate an inference depth based on a sequence image using the depth network 112, and output an initial inference pose based on the sequence image through the pose network 114 (S105).

The depth network 112, the pose network 114 and the synthetic image generator 118 constitute the synthetic image model 110, as illustrated in FIG. 3, and each network may be learned through training of the synthetic image model 110. The synthetic image model 110 may further include a dynamic region estimator 116 that generates a dynamic mask for forming a feature of a sequence image from which a dynamic region is filtered in the pose network 114, together with the networks 112 and 114 and the synthetic image generator 118.

The synthetic image model 110 may be trained using a pre-provided learning data set, for example, an original image including various objects. The various objects may include dynamic objects having mobility and static objects having no mobility. The dynamic objects for autonomous driving may be, for example, various types of mobility devices 200, pedestrians, and other agents having motion. The static objects for autonomous driving may include, for example, traffic facilities including roads, road signs, traffic lights, guard rails, and road markings for traffic control. The synthetic image model 110 may be a view synthesis based self-supervised depth estimation model, the details of which will be described later.

The original image may be, for example, a static image acquired in time series or sequentially from a camera mounted on the mobility device 200 or another device, and/or a dynamic image (video) representing a series of movements in an object as sequential frames. In the present disclosure, the sequence image may be an original static image captured sequentially in time series or an original dynamic image having sequential frames. The sequence image may be, for example, an image of the changing surrounding environment of an ego-vehicle acquired from a perspective of the driving ego-vehicle or an image of the changing surrounding environment acquired from each of multiple cameras of the ego-vehicle, by a mono camera mounted on the ego-vehicle. The sequence image may be a preprocessed image for an image acquired from a camera. In summary, the sequence image may be a plurality of images provided in time series or sequentially, and some of the plurality of images may be source images, and other images may be target images. For example, when the source image employs an image at a specific time, the target image may utilize an image that is related in time series to the source image. Specifically, the target image may be an image preceding or succeeding the source image in time. Hereinafter, the sequence image may be expressed as a source image and a target image. The source image and the target image may have changes in objects or pixel change values greater than a predetermined value in corresponding areas, and the areas having the changes/change values may correspond to dynamic areas between the images.

The depth network 112 may be a learning model that infers depth values per pixel of an image. The depth network 112 generates inference depths per pixel of the sequence image, and specifically, may generate source inference depths and target inference depths based on the source image and the target image, respectively. To this end, the depth network 112 may utilize an encoder-decoder that uses an appropriate neural network, for example, a convolutional layer and a multi-perceptron layer (MLP). The depth network 112 is not limited to the above-described examples, and may be implemented as a learning model in various ways.

The pose network 114 may be a learning model that infers a value corresponding to a translation and rotation transformation between the source image and the target image, i.e., an inference pose. The pose network 114 may estimate a transformation value of a pose that transforms a coordinate system of a camera that captured the target image into a coordinate system of a camera that captured the source image. The inference pose generated in step S105 may be an initial inference pose.

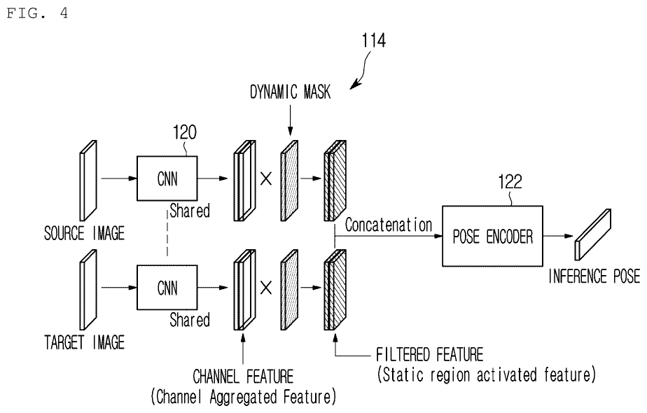

The pose network 114 may have a model structure as shown in FIG. 4. FIG. 4 shows an example of the structure of the pose network. The pose network 114 may include a convolutional layer 122 (also referred to as CNN) and a pose encoder 122 to identify pose changes of each of the source image and the target image.

The CNN 120 may extract channel features by applying a channel-specific kernel to the source image and the target image. A plurality of channels are provided to have different feature characteristics, and the number of channels may be experimentally determined. The weights constituting the kernel of the channel may be learnable parameters. In order to have information corresponding to each pixel of the source image and the target image, the kernel, for example, the size of the kernel, may be set to output channel features having the same size as the sequence image. Accordingly, the CNN 120 may output features aggregated by the plurality of channels, channel aggregated features. In the present disclosure, the channel aggregated features may simply be described as channel features for convenience of description.

The pose encoder 122 has a deep learning structure and may generate an inference pose based on information derived from channel features. The derived information may be channel features of raw source and target images in step S105. The derived information may be features obtained by filtering a dynamic region from channel features of each of the source and target images in step S115, which will be described later. The inference pose predicted in step S105 may be referred to as an initial inference pose in the present disclosure, and the inference pose predicted in step S115 may be referred to as a refined inference pose in the present disclosure. The pose encoder 122 may receive a combined channel feature that concatenates channel features of the source image and the target image, in order to generate the inference pose. The deep learning employed in the pose encoder 122 may be configured as, for example, a multi-perception layer (MPL), but is not limited thereto and may be constructed in various structures.

In relation to step S115, the filtered features input to the pose encoder 122 may be channel features whose dynamic region is eliminated or minimized by the dynamic mask from the channel features of the source and target images. The dynamic mask may be generated and input by the dynamic region estimator 116 in step S110. On the other hand, in relation to step S105, the dynamic mask may be functioned as or replaced by a mask that does not implement a filtering function, for structural consistency. The mask is not generated by the dynamic region estimator 116, and may be temporarily used only in the generation of the initial inference pose. Each weight constituting the mask of step S105 may be designated as 1, for example, so that all of the channel features pass through, and the filtered features may be substantially identical to the channel features. As another example, the dynamic mask may be omitted only in the generation of the initial inference pose, so that the channel features may be input directly to the pose encoder 122 without going through any mask.

Next, the processor 106 of the learning device 100 may generate a dynamic mask based on the synthetic depth and the target inference depth generated using the inference depth and the initial inference pose (S110).

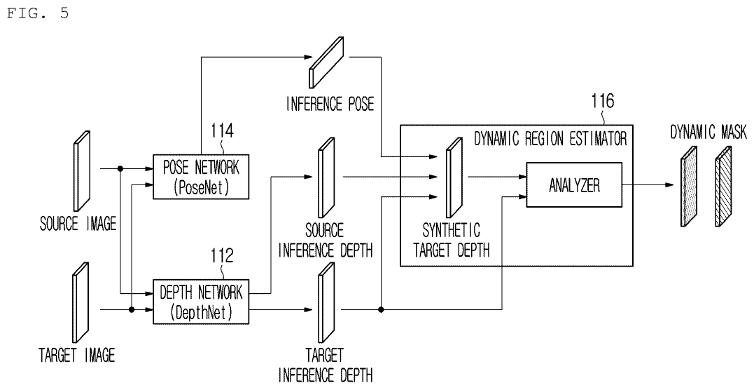

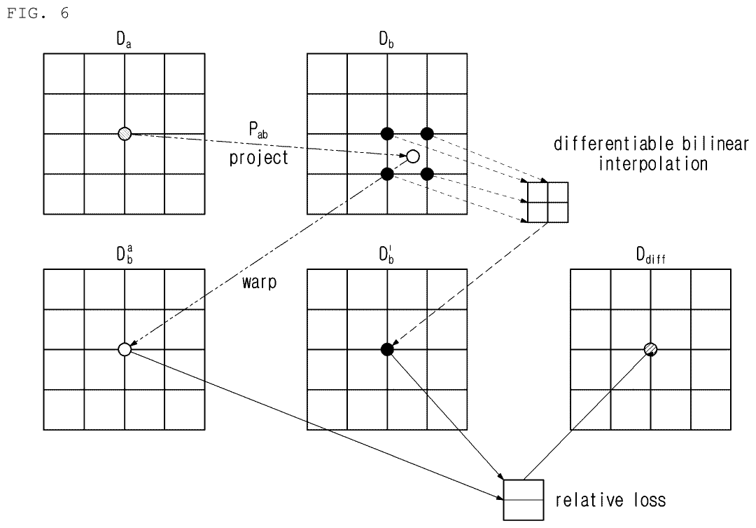

Step S110 will be described in detail with reference to FIGS. 5 and 6. FIG. 5 shows an example of a process of generating a synthetic depth and dynamic mask. FIG. 6 shows an example of the generation of a dynamic mask.

The dynamic mask may be generated using the dynamic region estimator 116 implemented by the processor 106, as shown in FIG. 5. The dynamic region estimator 116 may generate a synthetic depth, specifically, a synthetic target depth, based on the source inference depth, the target inference depth, and the initial inference pose. Then, the analyzer of the dynamic region estimator 116 may analyze the synthetic target depth and the target inference depth to identify the dynamic region, and generate a dynamic mask that eliminates or minimizes the dynamic region in each channel feature of the source and target images based on the dynamic region. That is, the dynamic mask may be generated for each source image and each target image, as shown in FIG. 4.

Referring to FIG. 6 to explain the generation of the synthetic target depth, the dynamic region estimator 116 may estimate a 3D target point of a target pixel position in the target image based on the target pixel position of the target inference depth, the target depth information of the target inference depth, and an intrinsic matrix related to an internal geometry of the sequence image. The internal geometry is, for example, an inherent property of a camera that acquires the sequence image, and the intrinsic matrix may be a transformation matrix according to the internal geometry. Then, the dynamic region estimator 116 may apply the initial inference pose to the 3D target point to transform the 3D target point into a 3D source point of the source image, as illustrated in Da of FIG. 6.

Next, the dynamic region estimator 116 may identify a source pixel position projected at the source inference depth by applying the intrinsic matrix to the 3D source point. The projected source pixel position may be identified using differentiable bilinear interpolation. The dynamic region estimator 116 may determine the source pixel position corresponding to the target pixel position of the target inference depth, as illustrated in Db of FIG. 6, by referring to the source pixel position used as the source inference depth. The dynamic region estimator 116 may warp the source inference depth at the source pixel position to the target pixel position to generate a synthetic target depth, as illustrated in D_{b}^{a} of FIG. 6.

Referring to FIG. 6 to explain the generation of the dynamic mask, the analyzer of the dynamic region estimator 116 may analyze the synthetic target depth in D_{b}^{a} of FIG. 6 and the target inference depth in D_{b}′ of FIG. 6 to generate a depth map, as illustrated in D_{diff} of FIG. 6. The target inference depth may be output from the depth network 112 based on the target image. The target inference depth may be related to the target inference depth of the target pixel position illustrated in D_{b} of FIG. 6. The depth map related to the dynamic mask may be generated to match the size of the sequence image while having the spatial dimension of the feature in each channel. In addition or alternative, the depth map related to the dynamic mask may be generated for each source image and each target image, similarly to FIG. 4.

With respect to the depth map, the analyzer may identify a dynamic region determined based on the difference between the synthetic target depth and the inference target depth. The dynamic region is determined as a pixel of the depth map corresponding to a case where the difference is greater than or equal to a threshold value, and the determined pixel may additionally or alternatively have a factor including a difference value. The factor related to the difference value may be calculated to have a weight between 0 and 1 through a predetermined method. On the other hand, if the difference is less than the threshold value, the pixel may be regarded as a static region of the depth map. The depth map may be generated to include the dynamic region, the static region, and the factor related to the difference value. The determination of the dynamic region and the static region of the depth map is not limited to the examples described above, and may be determined in various ways.

The dynamic mask may be set to have a smaller weight for a dynamic region with a larger amount of change or degree of change, in order to filter out the dynamic region and highlight the static region from channel features extracted from the source and target images. If the weight of the depth map increases as the amount of change in the dynamic region increases, the analyzer may generate the dynamic mask according to the above-described matters by subtracting the weight of the depth map pixel by pixel from a map in the form of a matrix having a weight of 1 for all pixels, for example. If the weight of the depth map decreases as the amount of change in the dynamic region increases, the analyzer may employ the depth map as the dynamic mask.

Although, in the above example, the dynamic mask is described as being generated using the source inference depth, the target inference depth, and the initial inference pose, as another example, the dynamic mask may be generated using the semantic segmentation information of each of the source and target images and the initial inference pose, instead of the inference depth. According to another example, a pre-trained model for semantic segmentation may be additionally or alternatively provided.

Referring back to FIG. 2, the processor 106 may generate a refined inference pose based on the sequence images (i.e., source and target images) and the dynamic mask by the pose network 114 (S115).

The operation of the pose network 114 that generates the refined inference pose is substantially the same as the pose network 114 that forms the initial inference pose described in step S105, except that the inference pose is generated based on features filtered by the dynamic mask.

Referring to FIG. 4 to describe step S115, the processor 106 may extract features for each of a plurality of channels for the source and target images by using the CNN 120 of the pose network 114, and generate channel features. The kernel for extracting the channel features is substantially the same as the description of step S105. Next, the processor 106 may output features filtered to block the dynamic region from the channel features by using the dynamic mask formed and received by the dynamic region estimator 116. Specifically, the processor 106 may apply the dynamic mask corresponding to the channel feature of the source image and the channel feature of the target image to each channel feature, and output each filtered feature corresponding to the source image and the target image. The filtered channel feature of each image may be formed by performing an element-wise product with the dynamic mask for each channel. Subsequently, the processor 106 may concatenate filtered features, and encode the concatenated feature by the pose encoder 122 employing deep learning to generate the refined inference pose.

After the step of primarily generating the refined inference pose as in step S115, if the computational cost is sufficient, the processor 106 may repeat steps S110 and S115 at least once. Specifically, the processor 106 may generate a synthetic target depth using the source inference depth, the target inference depth, and the refined inference pose generated in step S115. The synthetic target depth may be formed substantially the same as the description of step S110. Subsequently, the processor 106 may generate a subsequent dynamic mask that replaces the dynamic mask primarily generated in step S110, based on the synthetic target depth and the inference target depth, substantially the same as the description of step S110. Subsequently, the processor 106 may generate a subsequent refined inference pose based on the source image, the target image, and the subsequent dynamic mask by the pose network 114 to replace the refined inference pose of step S115.

The processor 106 may additionally or alternatively execute the above-described processes according to steps S110 and S115 until a predetermined condition is satisfied. The predetermined condition may be, for example, a specified number of times, or that the repeatedly generated subsequent refined inference pose converges to a preset value. In the case of additional repetitions, the previously formed subsequent refined inference pose may be used to generate the subsequent dynamic mask according to step S110, and the generated subsequent dynamic mask may be utilized to generate the subsequent refined inference pose according to step S115.

Referring back to FIG. 2, the processor 106 may train the depth network 112 and the pose network 114, by training the synthetic image model 110 having the depth network 112 and the pose network 114 to generate a synthetic image based on the sequence images (i.e., source and target images), the source and target inference depths, and the refined inference poses (or the subsequent refined inference poses) (S120).

Training according to step S120 may be processed by disabling the dynamic region estimator 116 and training the networks of the synthetic image model 110, i.e., the depth network 112 and the pose network 114.

The synthetic image model 110 may be a view synthesis based self-supervised depth estimation model as described above. The self-supervised depth estimation may calculate a loss function for the synthetic image by using the sequence image, such as the target image, input to the synthetic image model 110, without selecting and using correct data (ground truth data), i.e., a correct image, from the learning data (sequence image).

The synthetic image may be generated by the synthetic image generator 118, as illustrated in FIG. 3, and the synthetic image generator 118 may receive the source inference depth of the source image output through the depth network 112, the inference pose output from the source and target images by the pose network 114 with the dynamic mask, and the sequence image. The synthetic image generator 118 may generate a synthetic image similar to the target image based on the received information.

The depth network 112 and the pose network 114 of the synthetic image model 110 may be trained until the loss value of the loss function that calculates the similarity between the target image and the synthetic image converges to a predetermined value or reaches a minimum value. The parameters to be learned may be the filter weights of the convolutional layer of each network, the weights of the MLP constituting the encoder, etc. The networks 112 and 114 may be learned in a state where the weights of the dynamic mask are frozen. The loss function may be configured to have at least one of, for example, a similarity-based loss function (SSIM), L1, or a smoothness loss. In addition or alternative, the loss value of the loss function may be calculated by utilizing the loss based on the synthetic image and the target image to which the weights of the dynamic mask are respectively applied. Accordingly, pixels corresponding to the dynamic region in the synthetic image, the target image, and/or the channel features of these images are excluded as much as possible, so that the computational accuracy of the loss function may be secured.

According to the present disclosure, accurate pose inference of an image having a dynamic environment may be realized, thereby improving the learning performance of depth estimation. In addition or alternative, a pose network including a dynamic mask that prevents inaccuracy in pose inference due to a dynamic environment may be provided. Specifically, a feature filtering technique that effectively utilizes the dynamic mask without damaging image information may be utilized in the pose network.

After training is completed, the learning device 100 transmits the learned depth network 112 to the mobility device 200, so that the mobility device 200 may perform analysis of the image acquired from the camera 204b and driving control, etc. using the depth network 112.

Hereinafter, the mobility device 200 that receives the trained depth network 112 from the learning device 100 in FIG. 2 and other devices that communicate with the device will be described.

FIG. 7 shows an example of a mobility device communicating with another device to transmit and receive data.

The mobility device 200 may refer to a device that may move to a specific point, as described above in FIG. 1. In the present disclosure, the mobility device 200 is described as a vehicle that runs on the ground, but the present disclosure may also be applied to a mobility device for flying or water transportation. The mobility device 200 may be controlled and driven autonomously, as described above in FIG. 1, and the autonomous driving may be implemented as semi-autonomous driving or fully autonomous driving.

The mobility device 200 may be driven by electric energy or fossil energy. In the case of electric energy, the mobility device 200 may employ, for example, a pure battery-based vehicle driven only by a high-voltage battery or a gas-based fuel cell as an energy source. In addition or alternative, the fuel cell may utilize various forms of gas capable of generating electric energy, and the gas may be, for example, hydrogen. However, the present disclosure is not limited thereto, and various gases may be applied. In the case of fossil energy, the mobility device 200 is driven by fuel such as gasoline, diesel, or liquefied gas, and may be equipped with an engine that drives a wheel drive unit 214 by combustion of the fuel. The engine may be included in a power source unit 212 from the perspective of providing the wheel drive unit 214 with the driving rotational force of the wheels. As another example, the mobility device 200 may also be driven by a hybrid method of electric energy and fossil energy.

Meanwhile, the mobility device 200 may communicate with other devices 100 and 300 or another mobility device 400. The other devices may include, for example, the learning device 100 that supports various controls, status management, and driving of the mobility device 200, the ITS device 300 for receiving information from an Intelligent Transportation System (ITS), various types of user devices, etc. The learning device 100 may be, for example, an external device operated by a vehicle manufacturer or a management agency that provides autonomous driving services, as described above in FIG. 1.

The ITS device 300 is, for example, a road side unit (RSU), and the ITS device 300 may exchange vehicle recognition data, driving control and status data, environmental data around the vehicle, map data, etc. with the mobility device 200 via V2I to assist the user's self-driving or support autonomous driving of the mobility device 200. The mobility device 200 may exchange the data listed above with another mobility device 400 via V2V to support self-driving or autonomous driving.

The mobility device 200 may communicate with other vehicles or other devices based on cellular communication, WAVE (Wireless Access in Vehicular Environment) communication, DSRC (Dedicated Short Range Communication) or short-range communication, or other communication methods.

For example, the mobility device 200 may use a cellular communication network such as LTE or 5G, a Wi-Fi communication network, or a WAVE communication network, for communication with the learning device 100, the ITS device 300, and another mobility device 400.

As another example, DSRC or the like used in the mobility device 200 may be used for communication between vehicles. The communication method among the mobility device 200, the learning device 100, the ITS device 300, another mobility device 400, and the user device is not limited to the above-described example.

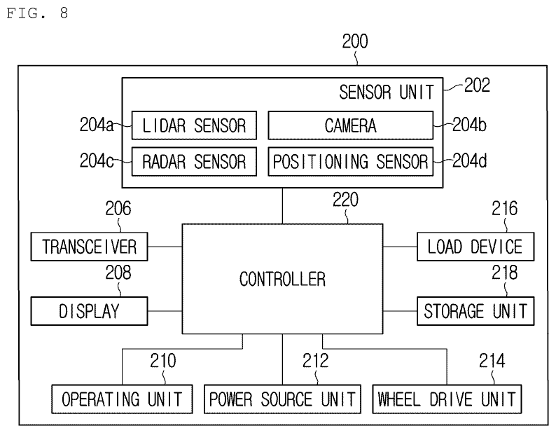

FIG. 8 shows an example of modules that constitute a mobility device according to the present disclosure. The mobility device 200 of FIG. 8 shows a ground vehicle.

The mobility device 200 may include a sensor unit 202, a transceiver 206, and a display 208.

The sensor unit 202 may be equipped with various types of detectors that detect various states and situations occurring in the external and internal environments of the mobility device 200 and determine the location information of the mobility device 200. That is, the sensor unit 202 is composed of a multi-sensor module including different types of sensors, and may acquire sensing data detected from each sensor.

Specifically, the sensor unit 202 may be equipped with a lidar sensor 204a, a camera 204b functioning as an image sensor, a radar sensor 204c to recognize dynamic and static objects existing around the mobility device 200, and may have a positioning sensor 104d to acquire location information of the vehicle. The sensor unit 202 may acquire sensor data including 3D recognition data, perception observation data, and location data by the above-described sensors.

The lidar sensor 204a may be a sensor that observes the surrounding environment based on laser scanning and perceives the three-dimensional shape of an object.

The camera 204b may acquire images (or image data) having two-dimensional image data or depth information about the surrounding environment and objects of the mobility device 200 in time series. The camera 204b may be installed in multiple parts of the mobility device 200, so that multiple images or multi-views of the surrounding environment of the mobility device 200 may be acquired.

The radar sensor 204c may, for example, irradiate radio waves of a predetermined wavelength to the surroundings and detect the behavior of the object based on the radio waves reflected from the object. The behavior of the object may include, for example, the presence or absence of the object, the movement of the object, a distance between the mobility device 200 and the object, the speed of the object, the direction of movement, etc.

The sensor unit 202 may be equipped with a gyro sensor, an acceleration sensor, a wheel sensor, an odometer, a speed sensor, etc., in addition or alternative to the positioning sensor 104d, in order to check its own position, driving posture, and speed. In addition or alternative, the sensor unit 202 may have an inward-facing image sensor, a biometric sensor that detects the biometric signals of the driver and passengers, and various detection modules that detect the operation and status of the internal devices, in order to monitor the status of users and passengers inside the mobility device 200 and the operation status of internal devices that may be operated by the user.

In the present disclosure, the sensors of the sensor unit 202 referred to in the description of the example are mainly described, but sensors that detect various situations not listed therein may be additionally or alternatively included.

The transceiver 206 may support mutual communication with the learning device 100, the ITS device 300, and the surrounding mobility device 400. In the present disclosure, the transceiver 206 may transmit data generated or stored during driving to the learning device 100, and receive data and software modules transmitted from the learning device 100. In the present disclosure, the mobility device 200 may transmit and receive data utilized in the method according to the present disclosure with the outside through the transceiver 206.

The display 208 may function as a user interface. The display 208 may display the output of the operation status of the mobility device 200, the control status, the route/traffic information, the remaining energy information, the content requested by the driver, etc. by a controller 106. The display 208 is configured as a touchscreen capable of detecting driver input, and may receive the driver's request that instructs the processor 106.

Meanwhile, the mobility device 200 may include an operating unit 210, a power source unit 212, a wheel drive unit 214, and a load device 216.

The operating unit 210 has at least one module that implements a driving operation, and may perform at least one driving operation among longitudinal control such as acceleration/deceleration and lateral control such as steering. The operating unit 210 may have various operating modules for causing the wheel drive unit 214 to generate a driving operation according to the request, including a pedal, a steering wheel, etc. that receive a user's request for the control.

The power source unit 212 may generate and supply power and electric power used for a driving power system such as the wheel drive unit 214 and a load device 114. If the mobility device 200 is driven based on electric energy, the power source unit 212 may be composed of, for example, an electric battery, or a combination of an electric battery and a fuel cell that charges the battery. In the case of a combination of an electric battery and a fuel cell, the power source unit 212 may include a tank that stores a material used to produce electric power of the fuel cell, such as hydrogen gas. If the mobility device 200 is driven based on fossil energy, the power source unit 212 may be composed of an internal combustion engine.

The wheel drive unit 214 may include a plurality of wheels, a driving force transmission module for generating driving force and applying or transmitting the driving force to the wheels, a braking module for decelerating the driving of the wheels, and a steering module for realizing lateral control of the wheels. If the mobility device 200 is driven based on electric energy, the driving force transmission module may be composed of a motor module for generating driving force based on power output from an electric battery. If the mobility device 200 is operated based on fossil energy, the driving force transmission module may be equipped with a transmission or gear module for transmitting power of an internal combustion engine.

In the present disclosure, the operating unit 210 and the wheel drive unit 214 may constitute an actuating unit that transmits power generated from the power source unit 212 to externally implement driving operations and postures, etc. In the present disclosure, the actuating unit is referred to as an actuator, and these terms may be used interchangeably.

The load device 216 is mounted on the mobility device 200 and may be an auxiliary device that consumes electric power supplied from the power source unit 212 or converted from the output of the power source unit 212 by use by a passenger or user. The load device 216 may be a type of non-driving electric device excluding a driving power system such as the wheel drive unit 214 in the present disclosure. The load device 114 may be, for example, an air conditioning system, a lighting system, a seat system, and various devices installed on the mobility device 200.

In addition or alternative, the mobility device 200 may include a storage unit 218 and a controller 220.

The storage unit 218 may store applications and various data for controlling the mobility device 200, and may load applications or read and record data at the request of the controller 220. In the present disclosure, the storage unit 218 may receive and manage a trained depth network 112 from the learning device 100. In addition or alternative, the storage unit 218 may receive and manage information necessary for driving, such as map information, traffic information, weather information, and accident information.

The controller 220 may perform overall control of the mobility device 200. The controller 220 may be configured to execute applications and instructions stored in the storage 218. Specifically, the controller 220 may estimate depth information of the image acquired from the camera 204b using the depth network 112 stored in the storage unit 218, and infer detection of an object in the image and occupancy information of the object by other networks desired for driving, such as an object detection model and a semantic segmentation model. The controller 220 may control driving based on the estimated or inferred information. In addition or alternative, the controller 220 may perform autonomous driving control based on information estimated from the image, together with various data recognized from the lidar sensor 204a, the radar sensor 204c, and the positioning sensor 204d.

An object of the present disclosure is to provide a method and device for learning an image network that improves the learning performance of depth estimation by realizing accurate pose inference of an image having a dynamic environment.

The technical problems solved by the present disclosure are not limited to the above technical problems and other technical problems which are not described herein will be clearly understood by a person (hereinafter referred to as an ordinary technician) having ordinary skill in the technical field, to which the present disclosure belongs, from the following description.

A method may be performed by an apparatus, of a vehicle, for learning an image network in a dynamic environment. The method may comprise: outputting an inference depth from a sequence image by a depth network and outputting an initial inference pose based on the sequence image by a pose network; generating a dynamic mask based on a synthetic depth generated using the inference depth and the initial inference pose, and the inference depth; generating a refined inference pose based on the sequence image and the dynamic mask, by the pose network; and training the depth network and the pose network, by training the synthetic image model having the depth network and the pose network to generate a synthetic image based on the sequence image, the inference depth and the refined inference pose.

The dynamic mask may be generated as a depth map representing a dynamic region determined according to a difference between the synthetic depth and the inference depth.

the dynamic mask may be a depth map generated to match a size of the sequence image while having a spatial dimension of a feature, so as to filter out a dynamic region from the feature by applying to the feature extracted from the sequence image.

The sequence image may include a source image and a target image related to the source image in time series, and the inference depth may include a source inference depth generated based on the source image and a target inference depth may generated based on the target image, and wherein the dynamic mask is generated for each of the source image and the target image.

The generating the dynamic mask may comprise: estimating a 3D target point of a target pixel position in the target image based on a target pixel position of the target inference depth, target depth information of the target inference depth, and an intrinsic matrix related to an internal geometry of the sequence image, and applying the initial inference pose to the 3D target point to transform the 3D target point into a 3D source point of the source image; determining the source pixel position corresponding to the target pixel position by identifying the source pixel position projected at the source inference depth by applying the intrinsic matrix to the 3D source point; warping the source inference depth of the source pixel position to the target pixel position to generate the synthetic depth; and generating the dynamic mask based on the synthetic depth and the target inference depth.

The synthetic image model may be a view synthesis based self-supervised depth estimation model trained using a loss function based on the synthetic image and the target image, and wherein the loss function utilizes a loss based on the synthetic image and the target image to which weights of the dynamic mask are respectively applied.

The generating the refined inference pose may comprise:
extracting a feature of the sequence image; outputting a feature filtered to block a dynamic region from the feature using the dynamic mask; and generating the refined inference pose by encoding the filtered feature.

The extracting the feature may comprise generating a channel aggregated feature using a plurality of channels having different feature characteristics, and wherein the channel has a kernel set to output a feature with the same size as the sequence image.

The sequence image may include a source image and a target image related to the source image in time series, and the dynamic mask is generated for each of the source image and the target image, wherein the extracting the filtered feature comprises applying the dynamic mask corresponding to each of a feature of the source image and a feature of the target image to each of the features and outputting each filtered feature corresponding to each of the source image and the target image, and wherein the generating the refined inference pose comprises concatenating each filtered feature and encoding the concatenated features to generate the refined inference pose.

After the generating the refined inference pose, may performing, at least once, steps of generating a subsequent dynamic mask based on a synthetic depth generated using the inference depth and the refined inference pose, and the inference depth to replace the dynamic mask and generating a subsequent refined inference pose based on the sequence image and the subsequent dynamic mask to replace the refined inference pose.

A device for learning an image network in a dynamic environment, the device may comprising: a memory configured to store at least one instruction; and a processor configured to execute the at least one instruction stored in the memory, wherein the processor is configured to:
output an inference depth from a sequence image by a depth network and output an initial inference pose based on the sequence image by a pose network; generate a dynamic mask based on a synthetic depth generated using the inference depth and the initial inference pose, and the inference depth, by a dynamic region estimator;
generate a refined inference pose based on the sequence image and the dynamic mask, by the pose network; and train the depth network and the pose network, by training the synthetic image model having the depth network and the pose network, in order to generate a synthetic image based on the sequence image, the inference depth and the refined inference pose.

The features of the present disclosure, which are briefly summarized herein, are only examples of examples of features of the present disclosure and detailed description of the disclosure which follows and are not intended to limit the scope of the present disclosure.

The technical problems solved by the present disclosure are not limited to the above mentioned technical problems. Other technical problems solved by the present disclosure, which are not described herein should be more clearly understood by a person having ordinary skill in the art of technical field to which the present disclosure belongs, from the following description.

According to the present disclosure, it is possible to provide a method and device for learning an image network that improves the learning performance of depth estimation by realizing accurate pose inference of an image having a dynamic environment.

In addition or alternative, a pose network including a dynamic mask that prevents inaccuracy in pose inference due to a dynamic environment may be provided. Specifically, a feature filtering technique that effectively utilizes the dynamic mask without damaging image information may be utilized in the pose network.

It will be appreciated by persons skilled in the art that that the effects that may be achieved through the present disclosure are not limited to what has been particularly described hereinabove and other advantages of the present disclosure will be more clearly understood from the detailed description.

While the methods of the present disclosure described above are represented as a series of operations for clarity of description, it is not intended to limit the order in which the steps are performed. The steps described above may be performed simultaneously or in different order as necessary. In order to implement the method according to the present disclosure, the described steps may further include different or other steps, may include remaining steps except for some of the steps, or may include other additional steps except for some of the steps.

The various examples of the present disclosure do not disclose a list of all possible combinations and are intended to describe representative examples of the present disclosure. Examples or features described in the various examples may be applied independently or in combination of two or more.

In addition or alternative, various examples (e.g., modules, units, etc.) of the present disclosure may be implemented in hardware, firmware, software, or a combination thereof. In the case of implementing the present disclosure by hardware, the present disclosure may be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various examples to be executed on an apparatus or a computer, a non-transitory computer-readable medium having such software or commands stored thereon and executable on the apparatus or the computer.

What is claimed is:

1. A method for controlling autonomous driving of a vehicle, the method comprising:
outputting, by a depth network, an inference depth from a sequence image;
outputting, by a pose network and based on the sequence image, an initial inference pose;
generating, based on a synthetic depth, a dynamic mask, wherein the synthetic depth is generated based on the inference depth and the initial inference pose, and the inference depth;
generating, by the pose network and based on the sequence image and the dynamic mask, a refined inference pose;
based on the sequence image, the inference depth, and the refined inference pose, training a synthetic image model comprising the depth network and the pose network to generate a synthetic image;
outputting a signal associated with the synthetic image; and
controlling, based on the signal, autonomous driving of the vehicle.

2. The method of claim 1, wherein the dynamic mask is generated as a depth map representing a dynamic region, wherein the dynamic region is determined based on a difference between the synthetic depth and the inference depth.

3. The method of claim 1, wherein the dynamic mask is a depth map, wherein the depth map is generated to match a size of the sequence image based on having a spatial dimension of a feature,
wherein the depth map is applied to the feature to filter out a dynamic region from the feature, wherein the feature is extracted from the sequence image.

4. The method of claim 1,
wherein the sequence image comprises a source image and a target image related to the source image in time series,
wherein the inference depth comprises a source inference depth generated based on the source image and a target inference depth generated based on the target image, and
wherein the dynamic mask is generated for each of the source image and the target image.

5. The method of claim 4, wherein the generating the dynamic mask comprises:
estimating a three-dimensional (3D) target point of a target pixel position in the target image based on:
a target pixel position of the target inference depth,
target depth information of the target inference depth, and
an intrinsic matrix related to an internal geometry of the sequence image,
applying the initial inference pose to the 3D target point to transform the 3D target point into a 3D source point of the source image;
determining a source pixel position corresponding to the target pixel position, wherein the source pixel position is projected at the source inference depth by applying the intrinsic matrix to the 3D source point;
warping the source inference depth, based on a source pixel position, to the target pixel position to generate the synthetic depth; and
generating, based on the synthetic depth and the target inference depth, the dynamic mask.

6. The method of claim 4,
wherein the synthetic image model is a view synthesis based self-supervised depth estimation model, wherein the view synthesis based self-supervised depth estimation model is trained based on a loss function, and
wherein the loss function utilizes a loss based on the synthetic image and the target image to which weights of the dynamic mask are respectively applied.

7. The method of claim 1, wherein the generating the refined inference pose comprises:
extracting a feature of the sequence image;
outputting, based on the dynamic mask, a feature filtered to block a dynamic region from the feature; and
generating the refined inference pose by encoding the filtered feature.

8. The method of claim 7,
wherein the extracting the feature comprises generating, based on a plurality of channels having different feature characteristics, a channel aggregated feature, and
wherein the channel has a kernel set to output a feature with the same size as the sequence image.

9. The method of claim 7,
wherein the sequence image comprises a source image and a target image related to the source image in time series,
wherein the dynamic mask is generated for each of the source image and the target image,
wherein the extracting the feature comprises:
applying the dynamic mask to each of a feature of the source image and a feature of the target image, wherein the dynamic mask corresponds to each of the feature of the source image and the feature of the target image; and
outputting each filtered feature corresponding to each of the source image and the target image, and
wherein the generating the refined inference pose comprises concatenating each filtered feature and encoding the concatenated features to generate the refined inference pose.

10. The method of claim 1, further comprising, after the generating the refined inference pose, performing:
generating, based on a synthetic depth, a subsequent dynamic mask, wherein the synthetic depth is generated based on the inference depth and the refined inference pose;
generating the inference depth to replace the dynamic mask; and
generating, based on the sequence image and the subsequent dynamic mask, a subsequent refined inference pose to replace the refined inference pose.

11. An apparatus for controlling autonomous driving of a vehicle, the apparatus comprising:
a processor; and
a memory configured to store at least one instruction, that when executed by the processor, is configured to cause the apparatus to:
output, by a depth network, an inference depth from a sequence image;
output, by a pose network and based on the sequence image, an initial inference pose;
generate, by a dynamic region estimator and based on a synthetic depth, a dynamic mask, wherein the synthetic depth is generated based on the inference depth and the initial inference pose, and the inference depth;
generate, by the pose network and based on the sequence image and the dynamic mask, a refined inference pose; and
based on the sequence image, the inference depth, and the refined inference pose, train a synthetic image model comprising the depth network and the pose network to generate a synthetic image;
output a signal associated with the synthetic image; and
control, based on the signal, autonomous driving of the vehicle.

12. The apparatus of claim 11, wherein the dynamic mask is generated as a depth map representing a dynamic region, wherein the dynamic region is determined based on a difference between the synthetic depth and the inference depth.

13. The apparatus of claim 11, wherein the dynamic mask is a depth map, wherein the depth map is generated to match a size of the sequence image based on having a spatial dimension of a feature,
wherein the depth map is applied to the feature to filter out a dynamic region from the feature, wherein the feature is extracted from the sequence image.

14. The apparatus of claim 11,
wherein the sequence image comprises a source image and a target image related to the source image in time series,
wherein the inference depth comprises a source inference depth generated based on the source image and a target inference depth generated based on the target image, and
wherein the dynamic mask is generated for each of the source image and the target image.

15. The apparatus of claim 14, wherein the dynamic mask is generated by:
estimating a three-dimensional (3D) target point of a target pixel position in the target image based on:
a target pixel position of the target inference depth,
target depth information of the target inference depth, and
an intrinsic matrix related to an internal geometry of the sequence image,
applying the initial inference pose to the 3D target point to transform the 3D target point into a 3D source point of the source image;
determining a source pixel position corresponding to the target pixel position, wherein the source pixel position is projected at the source inference depth by applying the intrinsic matrix to the 3D source point;
warping the source inference depth, based on a source pixel position, to the target pixel position to generate the synthetic depth; and
generating, based on the synthetic depth and the target inference depth, the dynamic mask.

16. The apparatus of claim 14,
wherein the synthetic image model is a view synthesis based self-supervised depth estimation model, wherein the view synthesis based self-supervised depth estimation model is trained based on a loss function, and
wherein the loss function utilizes a loss based on the synthetic image and the target image to which weights of the dynamic mask are respectively applied.

17. The apparatus of claim 11, wherein the refined inference pose is generated by:
extracting a feature of the sequence image;
outputting, based on the dynamic mask, a feature filtered to block a dynamic region from the feature; and
generating the refined inference pose by encoding the filtered feature.

18. The apparatus of claim 17,
wherein the extracting the feature comprises generating, based on a plurality of channels having different feature characteristics, a channel aggregated feature, and
wherein the channel has a kernel set to output a feature with the same size as the sequence image.

19. The apparatus of claim 17,
wherein the sequence image comprises a source image and a target image related to the source image in time series,
wherein the dynamic mask is generated for each of the source image and the target image,
wherein the extracting the feature comprises:
applying the dynamic mask to each of a feature of the source image and a feature of the target image, wherein the dynamic mask corresponds to each of the feature of the source image and the feature of the target image; and
outputting each filtered feature corresponding to the source image and the target image, and
wherein the generating the refined inference pose comprises concatenating each filtered feature and encoding the concatenated features to generate the refined inference pose.

20. The apparatus of claim 11, wherein the at least one instruction, when executed by the processor, is configured to cause the apparatus to, after generating the refined inference pose, perform:
generating, based on a synthetic depth, a subsequent dynamic mask, wherein the synthetic depth is generated based on the inference depth and the refined inference pose;
generating the inference depth to replace the dynamic mask; and
generating, based on the sequence image and the subsequent dynamic mask, a subsequent refined inference pose to replace the refined inference pose.
